(19) United States
(12) Patent Application Publication
(10) Pub. No.: US 2017/0295620 A1
(43) Pub. Date: Oct. 12, 2017

(54) Dim to Warm LED Lighting System

(71) Applicant: Tempo Industries, LLC, Irvine, CA (US)

(72) Inventors: Michael D. Bremser, Seal Beach, CA (US); Dennis Barton, Costa Mesa, CA (US)

(73) Assignee: Tempo Industries, LLC, Irvine, CA (US)

(21) Appl. No.: 15/462,796

(22) Filed: Mar. 17, 2017

Related U.S. Application Data
(60) Provisional application No. 62/320,515, filed on Apr. 9, 2016.

(51) Int. Cl. H05B 33/08

(52) U.S. Cl. CPC H05B 33/0845; H05B 33/0857; H05B 33/0809

(57) ABSTRACT

First and second LED channels of different color temperatures are connected to respective first and second FET drivers. A wall dimmer output is connected to a driver circuit and to circuitry which generates a variable DC voltage. A microcontroller is configured to employ a signal derived from the driver circuit output to generate changing PWM signals which are supplied along with the variable DC voltage to each of the first and second FET drivers to create variable mixed light color and brightness.

### RELATED APPLICATION

This application claims the benefit of and priority to U.S. Provisional Patent Application Ser. No. 62/320,515, filed Apr. 9, 2016, entitled, “Dim to Warm LED Lighting System,” the contents of which is incorporated by reference herein in its entirety.

### FIELD OF THE DISCLOSURE

The subject disclosure relates to LED electric lighting systems, and more particularly to a system which may replicate the lighting characteristics of incandescent filament lamps.

### DESCRIPTION OF RELATED ART

Various LED electric light fixtures have been constructed in the past, for example, such as those disclosed in U.S. Pat. Nos. 7,726,840 and 8,864,347, both assigned to Tempo Industries, LLC.

### SUMMARY

In an illustrative embodiment, first and second LED channels of different color temperatures are connected to first and second FET drivers. A wall dimmer output is connected to a driver circuit and to circuitry which generates a variable DC voltage, and a microcontroller is configured to employ a signal derived from the output of the driver circuit and representative of a current dimmer setting to generate first and second pulse width modulated (PWM) signals. The first and second PWM signals are supplied respectively to each of the first and second FET drivers along with the variable DC voltage to create a variable mixed light color and brightness output.

### DESCRIPTION OF THE DRAWINGS

FIG. 1 is a schematic circuit block diagram of an LED light system according to an illustrative embodiment;

FIG. 2 is an enlarged view of a first portion of the block diagram of FIG. 1; and

FIG. 3 is an enlarged view of a second portion of the block diagram of FIG. 1.

### DETAILED DESCRIPTION OF ILLUSTRATIVE EMBODIMENTS

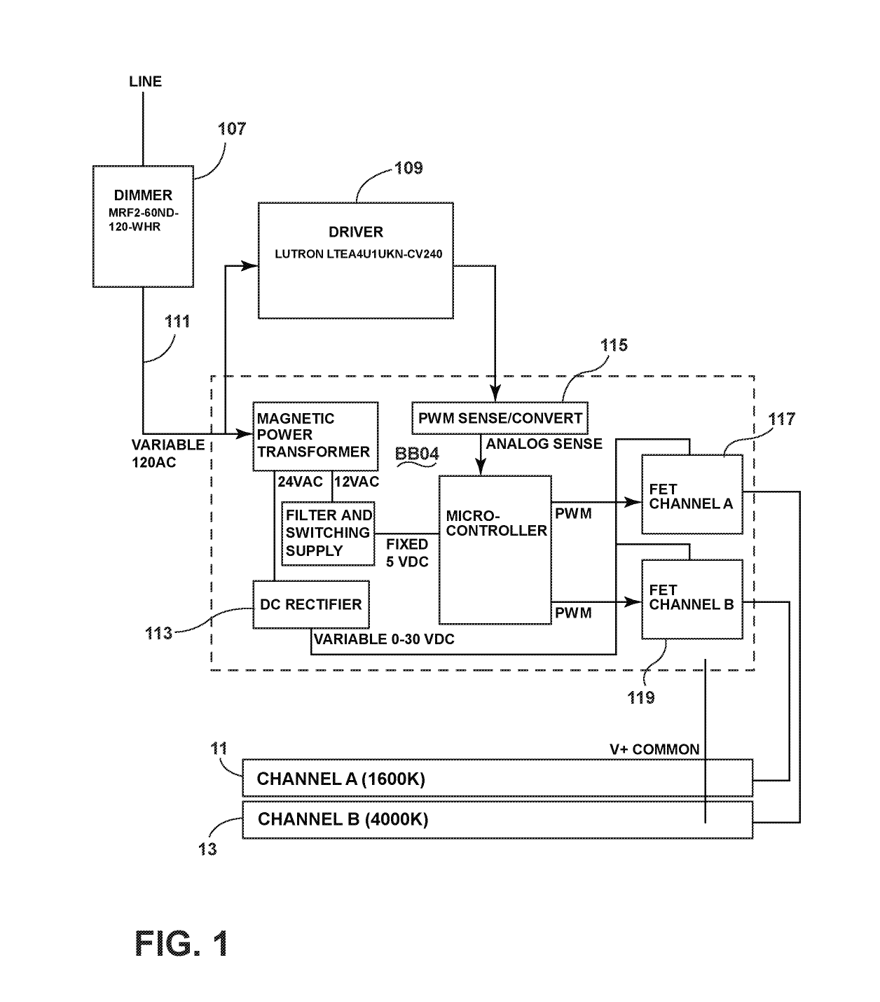

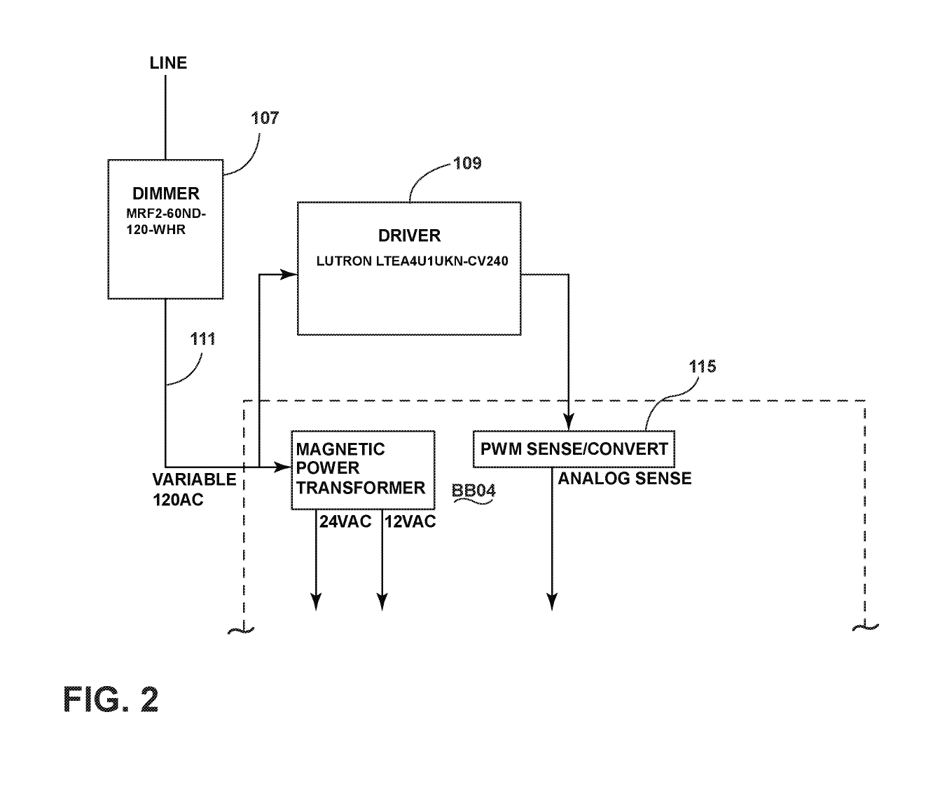

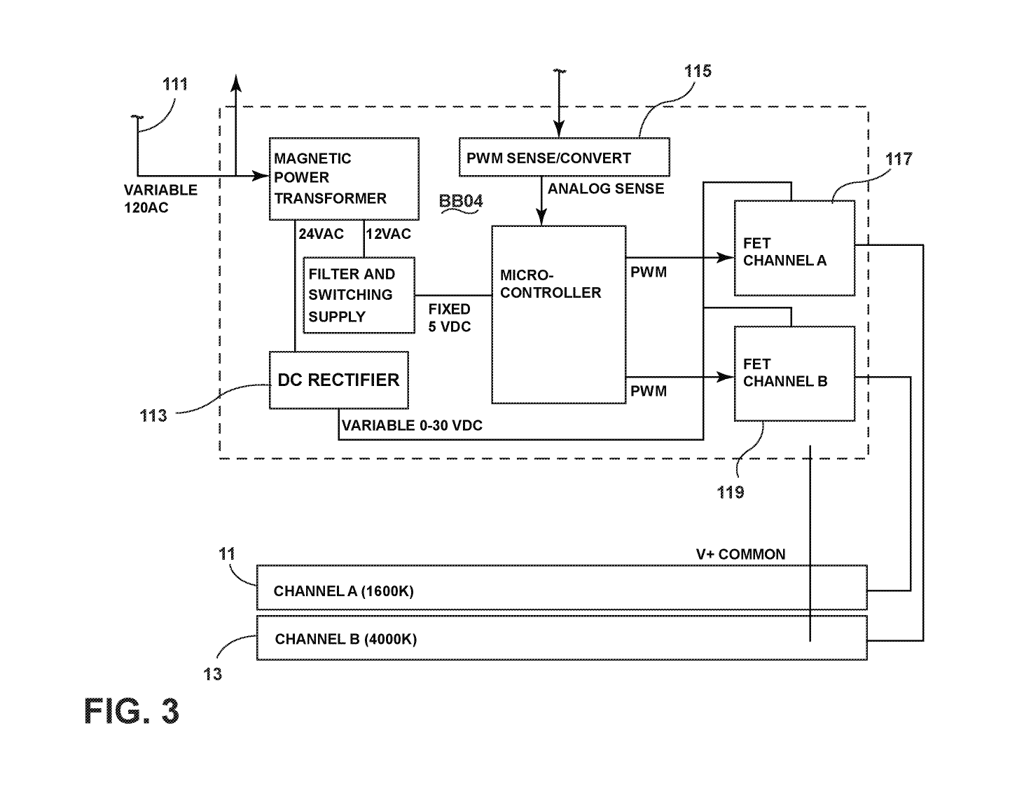

In the illustrative embodiment shown in the FIGS. 1-3, a standard Lutron MRF2 dimmer 107 is used to power and control the dimming. The dimmer 107 feeds a Lutron LTEAU1UKN-CV240 driver 109, which is used in tandem with circuitry BBO4 to control two strings of LEDs 11, 13, to create light of a variable mixed color and brightness. In operation of the illustrative embodiment, as the dimmer output level is reduced, the effective light color shifts from 4000 k to 1600 k, going from cool to warm.

The output of the wall dimmer 107 exclusively provides all power needed on signal line 111 to operate the system. The dimmer 107 outputs a phase controlled AC signal. That signal is split and is sent to the BB04 circuitry and to the Lutron driver 109. In the BB04 circuitry, this voltage is used to power a magnetic power transformer with two secondary voltages. One secondary voltage is 12 v AC, and a second is 24 v AC. The 12 v AC secondary voltage will vary based on the primary voltage at the power transformer, which varies as you dim.

The changing 12 v AC voltage is then fed to a filter and switching supply, which allows a wide range of workable voltage inputs. In the illustrative embodiment, the switching supply design handles these varying voltages, and translates that variable input into a fixed 5 v DC output, which is used to power a microcontroller, and will do so when dimmed even when below the range of LED illumination.

In the illustrative embodiment, the 24 v AC secondary winding is used to feed a second power supply section 113, at twice the value of the first, again with a standard bridge/cap combo to become a changing zero to 30 volt DC voltage. This voltage will eventually drive the LEDs, so it is more heavily filtered to eliminate visual flicker.

The BB04 circuitry also has an input for the return 110 from the output of the Lutron driver 109. This return 110 is a pulse width modulated (PWM) signal. While this PWM signal could be read directly by the microcontroller, in the illustrative embodiment, it is fed to a PWM Sense/Convert circuit where an analog filter is used to convert the PWM signal to a simple DC voltage, which is hardware buffered for isolation, and then read by a 10 bit ADC (analog to digital converter) to determine a voltage level representing the current dimmer setting. Employing the analog filter simplifies the microcontroller's firmware code.

The input values to the microcontroller are read multiple times per second, averaged for stability in the microcontroller code, and sent by the microcontroller as changing PWM signals to a pair of FETs 117, 119, each for a respective color channel, which, in one embodiment, may respectively use 1600 k and 4000 k LEDs. The FETs 117, 119 switch the onboard varying 30 v DC supply, adjusting the effective brightness levels of each color of LED string 11, 13, as the dimmer level output of the dimmer 107 changes. As the dimmer output value changes, the levels of each channel A, B, change to provide a balance of 4000 k and 1600 k light, with overall brightness changing at the same time

In one embodiment, the microcontroller firmware may be written so that when the output of the dimmer 107 dips to the very bottom end, or to 0 volts, then the microcontroller will shut down. As the power is restored, the microcontroller boots back up and goes directly back into the program, measuring and setting the brightness levels. In one embodiment, a brownout level set in the microcontroller “fuses” to make this transition smoother in selected cases.

While the illustrative embodiment employs a microcontroller, those skilled in the art will appreciate that other forms of computing devices, such as a processor, microprocessor or discrete logic circuitry, could be employed to perform the tasks of the microcontroller in various other embodiments.

In another embodiment, a third channel of color may be added, with additional complexity in the fading algorithm. In such an embodiment, the brightness shift of each channel needs to account for the simultaneous voltage reduction, which is unique to this concept.

The just described system provides the capability to replicate the lighting characteristics of an incandescent filament lamp, whereby the CCT of the emitted light is reduced (becomes warmer on the Blackbody curve) as less power is applied to the bulb (i.e. as the bulb is dimmed), which may be desirable in certain applications such as restaurants or hospitality environments.

From the foregoing, those skilled in the art will appreciate that various adaptations and modifications of the just described illustrative embodiments can be configured without departing from the scope and spirit of the invention. Therefore, it is to be understood that, within the scope of the appended claims, the invention may be practiced other than as specifically described herein.

What is claimed is:

1. An LED light system comprising:
a first LED channel comprising one or more LEDs of a first color temperature and connected to a first FET driver;
a second LED channel comprising one or more LEDs of a second color temperature and connected to a second FET driver;
a wall dimmer having an output connected to a driver circuit and to a power transformer, the driver circuit having an output; and
a microcontroller configured to employ a signal derived from the output of the driver circuit representative of a current dimmer setting to supply PWM signals to each of the first and second FET drivers.

2. The LED lighting system of claim 1 further comprising a circuit comprising a DC rectifier for receiving an output from the power transformer and supplying a varying DC voltage to each of the first and second FET drivers.

3. A method comprising:
constructing a first LED channel comprising one or more LEDs of a first color temperature and connecting the first LED channel to a first FET driver;
constructing a second LED channel comprising one or more LEDs of a second color temperature and connecting the second LED channel to a second FET driver;
connecting an output of a wall dimmer to a driver circuit and to a power transformer, the driver circuit having an output; and
employing a signal derived from the output of the driver circuit representative of a current dimmer setting to supply PWM signals to each of the first and second FET drivers.

4. The method of claim 3 further comprising deriving a varying DC voltage from an output from the power transformer and supplying the varying DC voltage to each of the first and second FET drivers.
